(19) United States
(12) Patent Application Publication
(10) Pub. No.: US 2005/0218385 A1
(43) Pub. Date: Oct. 6, 2005

(54) Appliance for safe lifting and method for its use

(76) Inventor: Larry Lemelson, Carlsbad, CA (US)

Correspondence Address: Kenneth P. Krohn, Suite 320, 2131 Palomar Airport Road, Carlsbad, CA, 92009, US

(21) Appl. No.: 11/089,948

(22) Filed: Mar. 25, 2005

Related U.S. Application Data
(60) Provisional application No. 60/623,667, filed on Oct. 30, 2004.

(51) Int. Cl. B66F 3/00

(52) U.S. Cl. 254/126

(57) ABSTRACT

In one version, the present invention is generally comprised of a non-mechanical switch means that causes an electrically powered lifting device to cease operation if the user of the lifting device attempts to operate it beyond its operational limits. In various embodiments, the non-mechanical switch means may be comprised of a magnetic switch, an optical switch, or an infrared switch. In a second version, the present invention is generally comprised of a lifting device that includes such non-mechanical switch means as a part thereof. In a third version, the present invention includes a method of using such lifting device.

### CROSS REFERENCES TO OTHER APPLICATIONS

This application claims the benefit of U.S. provisional application No. 60/623,667, filed on Oct. 30, 2004. The full disclosure of this provisional application is incorporated herein by reference.

### BACKGROUND

The present invention generally relates to operational shutoff means for electrically powered lifting devices, as well as lifting devices that include operational shutoff means. More specifically, the present invention generally relates to operational shutoff means that cause an electrically powered lifting device to cease operation if the lifting device attempts to operate beyond its operational limits, a lifting device that includes such operational shutoff means, and a method of using such shutoff means and lifting device.

There currently exist in the relevant art electrically powered lifting devices that are used to lift loads, such as motor vehicles. For example, such lifting devices may be used to lift motor vehicles for maintenance purposes or to change a tire. Many of these lifting devices utilize what is commonly referred to as a “scissor-type” lifting mechanism. In these types of devices, an electric motor or other electrically driven device is used to rotate a drive rod, which in turn is used to drive four or more arm members that are pivotally connected to one another. The arm members are also pivotally connected to a base, which is usually positioned on the ground or floor, and a lifting plate, which is usually placed adjacent to the load to be lifted. As the drive rod rotates, the arm members move in a “scissor-type” action, which causes the base and the lifting plate to move apart. Examples of such lifting devices are illustrated in U.S. Pat. Nos. 6,029,950, 5,657,964, and 4,749,169. The disclosures of these U.S. patents are hereby incorporated herein by reference.

These devices, however, have certain shortcomings. For example, if the user attempts to operate the lifting device beyond its designed range of motion, portions of the lifting device (such as one or more of the arm members) may fail structurally, causing substantial damage to the lifting device. Such structural failure may also cause the lifting device to fail, so that the load lifted by the lifting device falls back to the surface from which it has been lifted. This fall may damage the load (such as a vehicle) and may also present a substantial safety hazard to persons and property in the area of the load. Thus, there is a need for a means that causes the operation of the lifting device to cease if the user attempts to operate the lifting device beyond its operational limits. Although certain mechanical devices, such as mechanical switches, have been devised to perform this function, these switches have shortcomings in that they may not function properly if they cannot make direct physical contact. For example, if a piece of gravel were to become lodged between portions of the lifting device, the switch may not close so that the lifting device continues to operate when it shouldn't. Therefore, there is a need for a non-mechanical means that causes the operation of the lifting device to cease if the user attempts to operate the lifting device beyond its operational limits.

### SUMMARY

The present invention is directed to operational shutoff means that cause an electrically powered lifting device to cease operation if the lifting device attempts to operate beyond its operational limits, a lifting device that includes such operational shutoff means, and methods of using such shutoff means and lifting device that meet the needs discussed above in the Background section. As described in greater detail below, the present invention, when used for its intended purposes, has many advantages over other devices known in the art, as well as novel features that result in a new operational shutoff means and lifting device and methods for their use that are not anticipated, rendered obvious, suggested, or even implied by any prior art means, devices or methods, either alone or in any combination thereof.

One embodiment of a first version of the present invention generally discloses an appliance for causing an electrically powered lifting device to cease operation if the lifting device attempts to operate outside of its designed range of motion. In this embodiment, the appliance is generally comprised of a non-mechanical switch operably attached to the electrically powered lifting device and switch connecting means, which are described in more detail below. In these embodiments, the electrically powered lifting device is comprised of a frame and an electric drive member operably connected to the frame, so that the electric drive member causes the frame to extend and retract. The switch connecting means is used to connect the non-mechanical switch to the electrical drive member. Also in this embodiment, the electrically powered lifting device has a design range of motion characterized by its most retracted state at one end of the design range of motion of the frame and by its most extended state at the other end of the design range of motion of the frame. In various embodiments, if the lifting device attempts to operate outside of the design range of motion, the non-mechanical switch interrupts the electric power supply to the electric drive member or produces an electronic signal that is communicated to the electrical drive member by the switch connecting means and causes the operation of the electric drive member to cease. In some embodiments of this first version of the invention, the non-mechanical switch may be a magnetic switch. In other embodiments, the non-mechanical switch may be an optical switch. In yet other embodiments, the non-mechanical switch may be an infrared switch.

In other embodiments of the first version of the present invention, the electrically powered lifting device may be comprised of at least a first arm member and a second arm member, and the non-mechanical switch is comprised of a signal member and a receptor member. In these embodiments, the first arm member and a second arm member are pivotally connected together so that they rotate about one another. In addition, the signal member produces a signal and is disposed on either the first arm. The receptor member is disposed on the second arm. The receptor member is positioned so that it operably receives the signal produced by the signal member when the signal member is positioned a predetermined distance from the receptor member, said predetermined distance corresponding to the most extended state or the most retracted state of the design range of motion, so that the receptor member causes operation of the lifting device to cease when the receptor member operably receives the signal produced by the signal member. In other embodiments of this first version of the present invention, the electrically powered lifting device is further comprised of a first upper arm, a first lower arm, a second upper arm, a second lower arm, a lifting plate, and a base. In these embodiments, the first upper arm, the first lower arm, the second upper arm, and the second lower arm each have two ends. One end of the first upper arm is pivotally connected to one end of the first lower arm, and one end of the second upper arm is pivotally connected to one end of the second lower arm. The other end of the first upper arm and the other end of the second upper arm are pivotally connected to the lifting plate, and the other end of the first lower arm and the other end of the second lower arm are pivotally connected to the base. The lifting plate and the base move in the plane defined by the design range of motion of the electrically powered lifting device. In some of these embodiments, the non-mechanical switch is comprised of a signal member, which produces a signal and is disposed on the second lower arm, and a first receptor member disposed on the first lower arm. In these embodiments, the first receptor member is positioned so that it operably receives the signal produced by the signal member when the signal member is positioned a predetermined distance from the first receptor member, said predetermined distance corresponding to the most extended state of the design range of motion of the frame. When the first receptor member operably receives the signal produced by the signal member, the first receptor member causes operation of the lifting device to cease. In other embodiments, the non-mechanical switch also comprises a second receptor member, which is disposed on the second upper arm. The second receptor member is also positioned so that it operably receives the signal produced by the signal member when the signal member is positioned a predetermined distance from the second receptor member, said predetermined distance corresponding to the most retracted state of the design range of motion of the frame. When the second receptor member receives the signal produced by the signal member, the second receptor member causes operation of the lifting device to cease. In some of these embodiments, the signal member may be a magnet and the signal is a magnetic field produced by the magnet. In such case, the first receptor member and the second receptor member may be comprised of a switch mechanism and a sensor that detects magnetic fields, wherein the switch mechanism is activated by the sensor when the sensor operably detects the magnetic field signal produced by the signal member. In other of these embodiments, the signal member may be light source and the signal is a beam of light produced by the light source. In these cases, the first receptor member and the second receptor member may be comprised of a switch mechanism and a sensor that detects the light beam produced by the light source, wherein the switch mechanism is activated by the sensor when the sensor operably detects the light beam signal produced by the signal member. In some of these embodiments, the light beam produced by the light source may be in the infrared wavelengths of the electromagnetic spectrum. In yet other embodiments, the appliance operates in substantially the same manner as described above, but the non-mechanical switch is comprised of a first signal member, which produces a first signal and is disposed on the first upper arm, and a receptor member disposed on the second upper arm. In some of these embodiments, the non-mechanical switch is further comprised of a second signal member, which produces a second signal and is disposed on the second lower arm.

Various embodiments of a second version of the present invention generally disclose an appliance for lifting loads. In this embodiment, the appliance is generally comprised of an electrically powered lifting device, which is further comprised of a frame, an electric drive member, and electric drive connecting means to connect the electric drive member to the frame, non-mechanical switch means operably attached to the frame, and switch connecting means for connecting the non-mechanical switch means to the electric drive member. In this embodiment, the electrically powered lifting device has a design range of motion characterized by its most retracted state at one end of the range of motion of the frame and by its most extended state at the other end of the design range of motion of the frame. The non-mechanical switch means causes the operation of the electric drive member to cease if the electrically powered lifting device attempts to operate outside of the design range of motion of the frame. In some embodiments of this second version of the invention, the non-mechanical switch means may be comprised of a magnetic switch. In other embodiments, the non-mechanical switch means may be comprised of an optical switch. In yet other embodiments, the non-mechanical switch means may be comprised of an infrared switch. In the various embodiments of this second version of the invention, the electrically powered lifting device may have substantially the same structure, features, characteristics and operation as the lifting device of the first version of the invention, and the non-mechanical switch may have substantially the same structure, features, characteristics and operation as the non-mechanical switch of the first version of the invention.

One embodiment of a third version of the present invention generally discloses a method of using a lifting appliance, wherein the lifting appliance has a non-mechanical safety shutoff switch. In this embodiment, the lifting appliance is comprised of a frame, an electric drive member, electric drive connection means to operably connect the electric drive member to the frame, a non-mechanical switch operably attached to the frame, and switch connecting means for connecting the non-mechanical switch to the electric drive member. Also in this embodiment, the lifting appliance has a design range of motion characterized by its most retracted state at one end of the range of motion of the frame and by its most extended state at the other end of the design range of motion of the frame, and the non-mechanical switch causes the operation of the electric drive member to cease if the lifting appliance attempts to operate outside of the design range of motion of the frame. In this embodiment, the method generally comprises the steps of activating the lifting appliance so that it engages in lifting a load and operating the lifting appliance until the non-mechanical switch causes the operation of the electrically powered jack assembly to cease when the electrically powered jack reaches its most extended state of the design range of motion or its most retracted state of the design range of motion. In various other embodiments of this third version of the invention, the lifting appliance may have substantially the same structure, features, characteristics and operation as the electrically powered lifting device of the first version of the invention, and the non-mechanical switch may have substantially the same structure, features, characteristics and operation as the non-mechanical switch of the first version of the invention and the non-mechanical switch means of the second version of the invention.

Thus, the present invention meets the needs described above in the Background section. For example, the non-mechanical switch provides a means to stop the operation of the lifting device if the lifting device attempts to operate beyond its design operating range. It is not necessary that direct contact be made between a signal member and a receptor member comprising the non-mechanical to activate the non-mechanical switch, which in turn causes the operation of the lifting device to cease. An obstruction positioned between portions of the lifting device should not interfere with operation of the non-mechanical switch.

There has thus also been outlined, rather broadly, the more primary features of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the following drawing. This invention may be embodied in the form illustrated in the accompanying drawing, but the drawing is illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWING

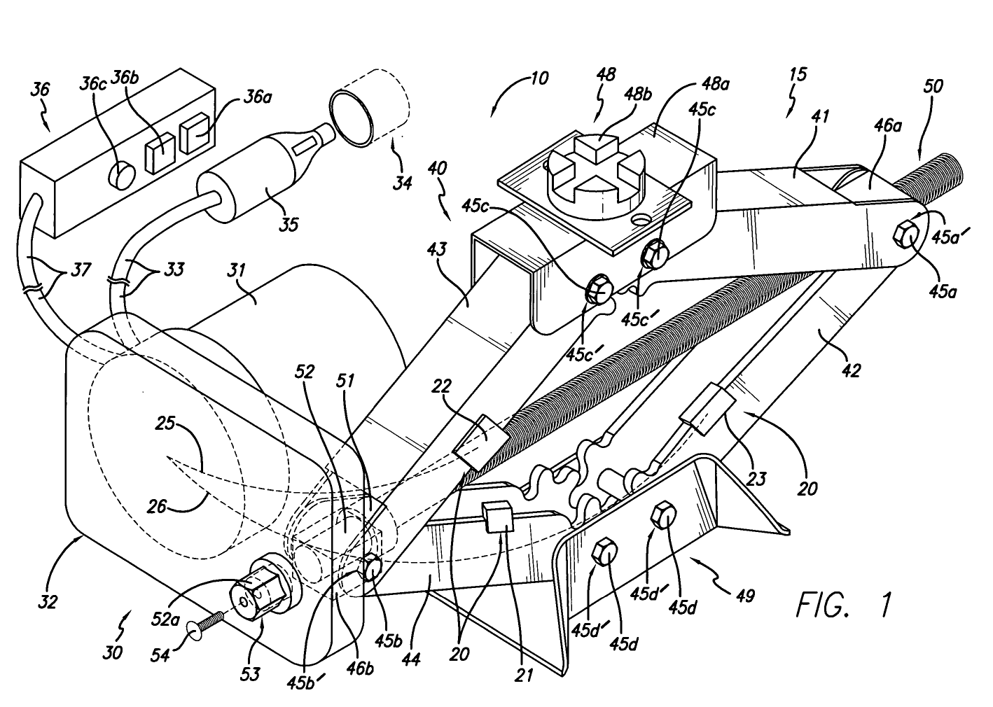

The foregoing summary, as well as the following description, will be better understood when read in conjunction with the appended FIG. 1, which is a perspective view of an embodiment of the appliance of the present invention, as viewed from the side of and above the appliance.

### DETAILED DESCRIPTION

Reference will now be made in detail to the preferred versions and embodiments of the present invention, examples of which are illustrated in the accompanying drawings. While the invention will be described in conjunction with the preferred versions and embodiments, it is to be noted that the versions and embodiments are not intended to limit the invention to those versions and embodiments. On the contrary, the invention is intended to cover alternatives, modifications and equivalents, which may be included within the spirit and scope of the invention as defined by the appended claims.

One embodiment of the present invention is illustrated in FIG. 1. In this embodiment, the present invention discloses an appliance 10, which is comprised of an electrically powered lifting device, generally designated 15, a non-mechanical switch, generally designated 20, and switch connecting means, which are described in more detail below. The appliance 10 may be used to lift loads, such as a vehicle (not shown) for maintenance purposes or to change a tire. It is to be noted that the lifting device 15 is a part of the present invention in some versions thereof, but is not a part of all versions of the present invention. In the embodiment illustrated in FIG. 1, the lifting device 15 is further comprised of an electric drive member, generally designated 30, a frame, generally designated 40, and a threaded drive rod 50. The electric drive member 30 is comprised of an electrically powered drive source (not shown) and a gear drive mechanism (not shown). The electrically powered drive source, which is positioned in a motor housing 31, may be any device currently known in the art or that may be developed in the art in the future that converts electrical energy into rotational energy in the form of a rotating shaft (not shown). For example, the electrically powered drive source may be an electric motor, which is well known in the relevant art. The rotating shaft of the electrically powered drive source drives the gear drive mechanism, which is positioned in the gear drive housing 32. The gear drive mechanism, in turn, drives the drive rod 50 by rotating it in the proper direction, as described in more detail below. It is to be noted that in various embodiments of the present invention the gear drive mechanism may be any type of gear drive mechanism currently known in the relevant art or that may be developed in the relevant art in the future. For example, the gear drive mechanism may have substantially the same structure, features, characteristics and operation as the drive device disclosed in U.S. Pat. No. 6,029,950, the disclosure of which is incorporated herein by reference. In some embodiments, as illustrated in FIG. 1, the gear drive mechanism is operably connected to the drive rod 50 by means of a collar 51 and shaft 52 assembly. Generally, the drive rod 50 is connected to the collar 51, which is also connected to the shaft 52, which is driven by the gear drive mechanism. These components in various combinations may act as the electric drive connection means in various embodiments of the present invention. In addition, in some embodiments, as illustrated in FIG. 1, a hand crank adapter 53 may be attached to the end of a shaft 52a (shown in phantom lines within the hand crank adapter 53), which may be an extension of the shaft 52 or another shaft 52a that is rotatably connected to the shaft 52 by means of the gear drive mechanism. The hand crank adapter 53 is connected to such shaft 52a by means of a screw 54 that is screwed into a threaded tap in the end of such shaft 52a. A socket wrench or hand ratchet (not shown) may be removably connected to the hand crank adapter 53 for purposes of operating the lifting device 15 if the power supply 34 fails or the power drive member 30 becomes inoperable.

The electrically powered drive source is supplied with electrical power by means of a power cord 33, which may be connected to any appropriate electrical power supply 34, which is a vehicle power outlet in the embodiment illustrated in FIG. 1. In various embodiments of the present invention, the power supply 34 may be any source of electrical power currently known in the relevant art or that may be developed in the relevant art in the future, such as a standard wall outlet, a vehicle power outlet (such as a cigarette lighter), a battery, or any other source of electrical power. The power cord 33 has a receptacle 35, which is a vehicle power outlet adapter in the illustrated embodiment, disposed on its distal end that is adapted to be connected to the electrical power supply 34. Such receptacles 35 are well known in the relevant art. It is to be noted that in various embodiments of the present invention, it may be necessary to include means to convert one type of electrical current to another. For example, if the electric drive source is powered by 12 volt DC current and the receptacle 35 is adapted to be connected to a 110 volt, 60 HZ AC outlet, it would be necessary to have an inverter operably connected between the receptacle 35 and the outlet to convert the 110 volt, 60 HZ AC outlet current to the 12 volt DC current required to operate the electric drive source. In the embodiment illustrated in FIG. 1, the operation of the electric drive member 30 is generally controlled by a control member 36, which is connected to the electric drive source by means of a cord 37. The control member 36 is generally comprised of a switch mechanism 36a, 36b. When one switch 36a is depressed, the electric drive source rotates in one direction, which causes the gear drive mechanism to drive the drive rod 50 in a given direction, causing the lifting device 15 to move in a given direction, as described in more detail below. When pressure on the switch 36a is released, so that the switch 36a is no longer in a depressed position, the electric drive source ceases to operate, so that the lifting device 15 ceases to operate (i.e., the lifting device 15 stops its movement). When the other switch 36b is depressed, the electric drive source rotates in the opposite direction, which causes the gear drive mechanism to drive the drive rod 50 in the opposite direction, causing the lifting device 15 to move in the opposite direction, as described in more detail below. When pressure on the switch 36b is released, so that the switch 36b is no longer in the depressed position, the electric drive source ceases to operate, so that the lifting device 15 ceases to operate (i.e., the lifting device 15 stops its movement). It is to be noted that in other embodiments, additional features may be included as a part of the control member 36, such as a device to regulate the speed of rotation of the electric drive source, and hence, the speed of movement of the lifting device 15. For example, a potentiometer, rheostat or other similar device, which are well known in the art, may be operably connected between the switch mechanism 36a, 36b and the control member cord 37 and may be controlled by a knob 36c or similar mechanism located on the control member 36.

In the embodiment of the appliance 10 illustrated in FIG. 1, the frame 40 of the lifting device 15 is comprised of a first upper arm 41, a first lower arm 42, a second upper arm 43, and a second lower arm 44. In this embodiment, the first upper arm 41, the first lower arm 42, the second upper arm 43, and the second lower arm 44 each have two ends and are approximately “U-shaped”. Although the first upper arm 41, the first lower arm 42, the second upper arm 43, and the second lower arm 44 are preferably constructed of a high strength steel or steel alloy, other materials, such as aluminum, titanium and other alloys, may also be used. In the illustrated embodiment, one end of the first upper arm 41 is pivotally connected to one end of the first lower arm 42 by means of a bolt 45a that is positioned in an opening 45a′ in the end of the first upper arm 41 and an opening 45a′ in the end of the first lower arm 42. The bolt 45a is screwed into a threaded tap in a generally rectangular block 46a that is positioned between the end of the first upper arm 41 and the end of the first lower arm 42. Another bolt (not shown) is also positioned on the opposite side of the lifting device 15 in an opening in the end of the first lower arm 42 and an opening in the end of the first lower arm 42 in substantially the same manner. The block 46a is also comprised of a threaded tap (not shown) that extends the entire length of the block 46a in a manner so that the drive rod 50 screws into and may extend through the entire length of the block 46a. It is to be noted that in other embodiments of the present invention, the block 46a may be of other shapes, such as square or polyhedral, and the pivotal connection may be made using means other than bolts 45a, such as rivets, screws and other fasteners. In the illustrated embodiment, one end of the second upper arm 43 is pivotally connected to one end of the second lower arm 44 in substantially the same manner as the one end of the first upper arm 41 is pivotally connected to one end of the first lower arm 42 using bolt 45a, as described above. This pivotal connection is also made by means of a bolt 45b that is screwed into a threaded tap in a generally rectangular block 46b that is positioned between the end of the second upper arm 42 and the end of the second lower arm 44. The block 46b extends to and is connected with the gear drive housing 32, so that the electric drive member 30 is mounted on and supported by the block 46b. In the illustrated embodiment, the other end of the first upper arm 41 and the other end of the second upper arm 42 are pivotally connected to a lifting plate 48 by means of bolt, lock washer, and nut combinations 45c that are positioned in concentric openings 45c′ in the other end of the first upper arm 41, the other end of the second upper arm 42, and the lifting plate 48. It should be noted that in other embodiments, almost any suitable means currently known in the relevant art or that may be developed in the relevant art in the future may be used to make this pivotal connection at the lifting plate 48. For example, in other embodiments, the pivotal connection may be made using bolts, pins, rivets, pin and cotter pin combinations, and other fasteners and means and combinations of all such means. It is also to be noted that in some embodiments, as illustrated in FIG. 1, the lifting plate 48 may be further comprised of a mounting bracket 48a and a lifting fixture 48b, which may be adapted to conform to the shape of a surface of the load, mounted on the top surface of the lifting bracket 48a. In the illustrated embodiment, the other end of the first lower arm 42 and the other end of the second lower arm 44 are pivotally connected to a base plate 49 by means of bolt, lock washer, and nut combinations 45d that are positioned in concentric openings 45d′ in the other end of the first lower arm 42, the other end of the second lower arm 44, and the base plate 49. It should be noted that in other embodiments, any means that may be used to make the pivotal connection with the lifting plate 48, as described above, may also be used to make the pivotal connection with the base plate 49.

In operation, and not considering the function of the non-mechanical switch 20, which is described in more detail below, the appliance 10 of the embodiment illustrated in FIG. 1 is placed under a load (not shown), such as a vehicle, to be lifted. Generally, the base plate 49 is placed against the floor, roadway, ground or other surface (not shown) that will be used to support the appliance 10 during the lifting process. The lifting plate 48 is generally positioned under or against a surface of the load to be lifted by the appliance 10. When the appliance 10 is positioned to lift the load, the frame 40 is typically in its most retracted state. In other words, the drive rod 50 has been rotated until the lifting plate 48 and the base plate 49 are the minimum distance apart in accordance with the design range of motion of the frame 40. The user of the appliance 10 connects the receptacle 35 to the power supply 34 (the vehicle power outlet in the illustrated embodiment), and using the control member 36, depresses the switch 36a, which causes the drive rod 50 to rotate. This rotation causes the ends of the upper arms 41, 43 and the ends of the lower arms 42, 44 that are pivotally connected at bolts 45a and 45b to be drawn toward one another in a scissor-type action, which causes the lifting plate 48 to move away from the base plate 49, thereby lifting the load. At some point in operation of the appliance 10, the rotation of the drive rod 50 will cause the frame 40 to be extended to its most extended state within the design range of motion of the frame 40. Generally, if the user of the appliance 10 attempts to extend the frame 40 beyond the most extended state in the design range of motion of the frame 40, it is possible that the frame 40 or one or more of its component parts will undergo structural failure. Such failure may cause substantial damage to the appliance 10. More significantly in many instances, such failure may cause the structural failure of the appliance 10, so that it is no longer capable of lifting the load or holding the load in a lifted state. In such circumstances, the load may fall, causing damage to the load, the support surface, objects in the vicinity of the load, or all of the same. The fall may also cause severe injury to the user of the appliance 10 or other persons in the vicinity or both. It should also be noted that any attempt to retract the frame 40 beyond the most retracted state of the design limit of the frame 40 may also cause structural failure or other damage to the frame 40 or one or more of its component parts.

Turning now to the operation of the non-mechanical switch 20, in the embodiment of the present invention illustrated in FIG. 1, the non-mechanical switch 20 is comprised of a signal member 21, which produces a signal and is disposed on the second lower arm 44. In this embodiment, the signal member 21 is comprised of a magnet, which produces a magnetic field as a signal. Further, in this embodiment, the non-mechanical switch 20 is also comprised of a second receptor member 22 disposed on the second upper arm 43 and a first receptor member 23 disposed on the first lower arm 42. In this embodiment, both the first receptor member 23 and the second receptor member 22 are comprised of a sensor that detects magnetic field strength and a switching mechanism that activates when the designated magnetic field strength is detected. Magnetic switches commonly known as Reed switches and Hall-effect switches, and other similar switches and combinations of all such switches, may be used for this purpose. The signal member 21 and the second receptor member 22 are positioned on the second lower arm 43 and the second upper arm 44, respectively, so that the second receptor member 22 operably receives the signal produced by the signal member 21 when the signal member 21 is positioned a predetermined distance from the second receptor member 22, said predetermined distance corresponding to the most retracted state of the design range of motion of the frame 40. In other words, in this embodiment, the second receptor member 22 is positioned on the second upper arm 44 and the signal member 21 is positioned on the second lower arm 43, so that when the frame 40 reaches the most retracted state in the design range of motion of the frame 40, the signal member 21 is close enough to the sensor of the second receptor member 22 so that the sensor detects the magnetic field signal produced by the magnet of the signal member 21. When the sensor of the second receptor member 22 detects the magnetic field of the signal member 21, the switching mechanism of the second receptor member 22, which is normally closed completing the circuit providing power to the power drive member 30 from the power supply 34, is opened, breaking the circuit. As a result, the appliance 10 ceases to operate so that the design range of motion of the frame 40 is not exceeded. In the illustrated embodiment, the switch connecting means is two or more electrically conductive leads in an insulating sheath (a wire 25) that connect the second receptor member 22 to the circuit providing electrical power to the electrically powered drive source. Although the wire 25 is the preferred switch connecting means, in other embodiments, the switch connecting means may be almost any suitable means currently known in the relevant art or that may be developed in the relevant art in the future, such as other conductors, RF and IR transmitters and receivers, and other means and combinations of all such means. In some embodiments, the switch 36a that controls the motion of the lifting device 15 in the upward (more extended) position may be equipped with an override switch (not shown), so that by depressing the switch 36a the power drive member 30 engages, extending the frame 40 and allowing the switch mechanism of the second receptor member 22 to be reset to the closed position. It is also to be noted that in other embodiments, the switch mechanism of the second receptor member 22 may normally be in the open position, so that when the sensor of the second receptor member 22 detects the magnetic field of the signal member 21, the switching mechanism of the second receptor member 22 closes, producing an electronic signal that is communicated by means of the switch connecting means to the electric drive member 30, which instructs the electric drive member 30 to cease operation. In the illustrated embodiment, the first receptor member 23 is positioned on the first lower arm 42 so that the first receptor member 23 operably receives the signal produced by the signal member 21 when the signal member 21 is positioned a predetermined distance from the first receptor member 23, said predetermined distance corresponding to the most extended state of the design range of motion of the frame 40. In other words, in this embodiment, the first receptor member 23 is positioned on the first lower arm 42 so that when the frame 40 reaches the most extended state in the design range of motion of the frame 40, the signal member 21 is close enough to the sensor of the first receptor member 23 so that the sensor detects the magnetic field signal produced by the magnet of the signal member 21. When the sensor of the first receptor member 23 detects the magnetic field of the signal member 21, the switching mechanism of the first receptor member 23, which is normally closed completing the circuit providing power to the power drive member 30 from the power supply 34, is opened, breaking the circuit. As a result, the appliance 10 ceases to operate so that the design range of motion of the frame 40 is not exceeded. In the illustrated embodiment, the switch connecting means is an electrically conductive wire 26 similar to the wire 25 used to connect the second receptor member 22, which connects the first receptor member 23 to the circuit providing electrical power to the electrically powered drive source. Although the wire 26 is the preferred switch connecting means, in other embodiments, the switch connecting means may be almost any suitable means, including all of the switch connecting means that may be used to connect the second receptor member 22 to the circuit providing electrical power to the electrically powered drive source, as described in more detail above. In some embodiments, the switch 36b that controls the motion of the lifting device 15 in the downward (more retracted) position may be equipped with an override switch (not shown), so that by depressing the switch 36b the power drive member 30 engages, retracting the frame 40 and allowing the switch mechanism of the second receptor member 22 to be reset to the closed position.

It is to be noted that in other embodiments of the present invention, the positions of the signal member 21, the first receptor member 23, and the second receptor member 22 may be changed as long as the functions of the non-mechanical switch 20 are not impaired. For example, a receptor member may be positioned on the second lower arm 44, a receptor member may be positioned on the first upper arm 41, and the signal member 21 may be positioned on the first lower arm 42. In addition, the component parts of the non-mechanical switch 20 may be varied. For example, a signal member may be positioned on the second upper arm 43, a signal member may be positioned on the first lower arm 42, and a receptor member may be positioned on the second lower arm 44. It is also to be noted that the non-mechanical switch 20 may only be used to terminate operation of the appliance 10 at one end of the design range of motion of the frame 40. For example, in other embodiments, the non-mechanical switch 20 may have a signal member positioned on the second upper arm 43 and a receptor member positioned on the second lower arm 44, which would cause operation of the appliance 10 to cease when the frame 40 reaches its most retracted state. Similarly, in other embodiments, the non-mechanical switch 20 may have a signal member on the second lower arm 44 and a receptor member positioned on the first lower arm 42, which would cause operation of the appliance 10 to cease when the frame 40 reaches its most extended state. In yet other embodiments, the signal member 21 may be a light source and the signal is light produced by the light source. In these embodiments, the light source may be powered by electric current from the same source that supplies power to the electric drive member 30 along suitable wires (not shown). Also in these embodiments, the first receptor member 23 and the second receptor member 22 each comprise a sensor that detects the light signal when the position of the signal member 21 corresponds to the most extended and most retracted design range of motion of the frame 40, respectively. The first receptor member 23 and the second receptor member 22 also each comprise a switching mechanism, which is normally closed, so that upon detecting the light signal from the signal member 21, each switching mechanism opens, breaking the circuit providing power from the power supply 34 to the electric drive member 30. In other embodiments, the first receptor member 23 and the second receptor member 22 also each comprise a switching mechanism that is normally open, so that upon detecting the light signal from the signal member 21, each switching mechanism produces an electronic signal that is communicated to the electrically powered drive source 30 in the same manner as described above.

In operation, and considering the function of the non-mechanical switch 20, the appliance 10 of the embodiment illustrated in FIG. 1 is placed under a load (not shown), the base plate 49 is placed against the supporting surface (not shown) that will be used to support the appliance 10 during the lifting process, and the lifting plate 48 is generally positioned under or against a surface of the load to be lifted by the appliance 10. The user of the appliance 10 connects the receptacle 35 to the power supply 34 (the vehicle power outlet in the illustrated embodiment), and using the control member 36, depresses the switch 36a, which causes the drive rod 50 to rotate. This rotation causes the ends of the upper arms 41, 43 and the ends of the lower arms 42, 44 that are pivotally connected at bolts 45a and 45b to be drawn toward one another in a scissor-type action, which causes the lifting plate 48 to move away from the base plate 49, thereby lifting the load. When the frame 40 is extended to its most extended state within the design range of motion of the frame 40, the first receptor member 23 of the non-mechanical switch 20 detects the magnetic field signal of the signal member 21 and causes the operation of the electrical drive member 30 to cease, so that the frame 40 cannot be extended beyond its design range of motion. When the frame 40 is retracted in the opposite direction and reaches its most retracted state within the design range of motion of the frame 40, the second receptor member 22 of the non-mechanical switch 20 detects the magnetic field signal of the signal member 21 and causes the operation of the electrical drive member 30 to cease, so that the frame 40 cannot be retracted beyond its design range of motion.

It is to be noted that a first version of the present invention comprises the non-mechanical switch 20 in any of the embodiments described herein, which may be used with any type of lifting device with a “scissor-type” of lifting action and is not limited to the type of lifting device 15 illustrated in FIG. 1. In this context, a “scissor-type” of lifting device includes any device that lifts loads and is comprised of members that are pivotally connected together and rotate relative to one another about the pivotal connection. It is also to be noted that a second version of the present invention comprises the non-mechanical switch 20 in any of the embodiments described herein and in combination with a lifting device, which may be any type of lifting device with a “scissor-type” of lifting action and is not limited to the type of lifting device 15 illustrated in FIG. 1. In this context, a “scissor-type” of lifting device also includes any device that lifts loads and is comprised of members that are pivotally connected together and rotate relative to one another about the pivotal connection. For example, in the case of embodiments of both the first and second versions of the present invention, the lifting device may have a structure substantially similar to that illustrated in FIG. 1 of U.S. Pat. No. 4,749,169, the disclosure of which is incorporated herein by reference. Finally, it is to be noted that the non-mechanical switch means of some embodiments of the present invention encompass the structure, characteristics, features and operation of all of the various embodiments related to the non-mechanical switch 20, as described above and illustrated in connection with FIG. 1.

1. An appliance for causing an electrically powered lifting device to safely cease operation, the appliance comprising:
(a) a non-mechanical switch operably attached to the electrically powered lifting device, wherein the electrically powered lifting device is further comprised of a frame and an electric drive member operably connected to the frame, so that the electric drive member causes the extension and retraction of the frame;
(b) switch connecting means for connecting the non-mechanical switch to the electric drive member;
(c) wherein the electrically powered lifting device has a design range of motion characterized by its most retracted state at one end of the range of motion of the frame and by its most extended state at the other end of the design range of motion of the frame, and the non-mechanical switch causes the operation of the electric drive member to cease if the electrically powered lifting device attempts to operate outside of the design range of motion of the frame.

2. The appliance of claim 1, wherein the non-mechanical switch is a magnetic switch.

3. The appliance of claim 1, wherein the non-mechanical switch is an optical switch.

4. The appliance of claim 1, wherein the non-mechanical switch is an infrared switch.

5. The appliance of claim 1, wherein:
(a) the frame is comprised of at least a first arm member and a second arm member, wherein the first arm member and the second arm member are pivotally connected together so that they rotate about one another; and
(b) the non-mechanical switch is comprised of:
(i) a signal member disposed on the first arm member, wherein the signal member produces a signal; and
(ii) a receptor member disposed on the second arm member, wherein the receptor member is positioned so that it operably receives the signal produced by the signal member when the signal member is positioned a predetermined distance from the receptor member, said predetermined distance corresponding to the most retracted state or the most extended state of the design range of motion of the frame, and the receptor member causes operation of the electric drive member to cease when the receptor member operably receives the signal produced by the signal member.

6. The appliance of claim 1, wherein:
(a) the frame is further comprised of a first upper arm, a first lower arm, a second upper arm, a second lower arm, a lifting plate, and a base, wherein:
(i) the first upper arm, the first lower arm, the second upper arm, and the second lower arm each have two ends;
(ii) one end of the first upper arm is pivotally connected to one end of the first lower arm;
(iii) one end of the second upper arm is pivotally connected to one end of the second lower arm;
(iv) the other end of the first upper arm and the other end of the second upper arm are pivotally connected to the lifting plate;
(v) the other end of the first lower arm and the other end of the second lower arm are pivotally connected to the base; and
(vi) the lifting plate and the base move in a plane defined by the design range of motion of the frame; and
(b) the non-mechanical switch is comprised of:
(i) a signal member disposed on the second lower arm, wherein the signal member produces a signal; and
(ii) a first receptor member disposed on the first lower arm, wherein:
(A) the first receptor member is positioned so that it operably receives the signal produced by the signal member when the signal member is positioned a predetermined distance from the first receptor member, said predetermined distance corresponding to the most extended state of the design range of motion of the frame; and
(B) the first receptor member causes operation of the electric drive member to cease when the first receptor member operably receives the signal produced by the signal member.

7. The appliance of claim 6, wherein the non-mechanical switch is further comprised of a second receptor member disposed on the second upper arm, wherein:
(a) the second receptor member is positioned so that it operably receives the signal produced by the signal member when the signal member is positioned a predetermined distance from the second receptor member, said predetermined distance corresponding to the most retracted state of the design range of motion of the frame; and
(b) the second receptor member causes operation of the electric drive member to cease when the second receptor member operably receives the signal produced by the signal member.

8. The appliance of claim 7, wherein:
(a) the signal member is comprised of a magnet and the signal is a magnetic field produced by the magnet; and
(b) the first receptor member and the second receptor member are each comprised of a switch mechanism and a sensor that detects magnetic fields, wherein the switch mechanism is activated by the sensor when the sensor operably detects the magnetic field signal produced by the signal member.

9. The appliance of claim 7, wherein:
(a) the signal member is comprised of a light source and the signal is a light beam produced by the light source; and
(b) the first receptor member and the second receptor member are each comprised of a switch mechanism and a sensor that detects the light beam produced by the signal member, wherein the switch mechanism is activated by the sensor when the sensor operably detects the light beam produced by the signal member.

10. The appliance of claim 9, wherein the light beam produced by the light source is in the infrared wavelengths of the electromagnetic spectrum.

11. The appliance of claim 1, wherein:
(a) the frame is further comprised of a first upper arm, a first lower arm, a second upper arm, a second lower arm, a lifting plate, and a base, wherein:
(i) the first upper arm, the first lower arm, the second upper arm, and the second lower arm each have two ends;
(ii) one end of the first upper arm is pivotally connected to one end of the first lower arm;
(iii) one end of the second upper arm is pivotally connected to one end of the second lower arm;
(iv) the other end of the first upper arm and the other end of the second upper arm are pivotally connected to the lifting plate;
(v) the other end of the first lower arm and the other end of the second lower arm are pivotally connected to the base; and
(vi) the lifting plate and the base move in a plane defined by the design range of motion of the frame; and
(b) the non-mechanical switch is comprised of:
(i) a first signal member disposed on the first upper arm, wherein the first signal member produces a first signal; and
(ii) a receptor member disposed on the second upper arm, wherein:
(A) the receptor member is positioned so that it operably receives the first signal produced by the first signal member when the first signal member is positioned a predetermined distance from the receptor member, said predetermined distance corresponding to the most extended state of the design range of motion of the frame; and
(B) the receptor member causes operation of the electric drive member to cease when the receptor member operably receives the first signal produced by the first signal member.

12. The appliance of claim 11, wherein the non-mechanical switch is further comprised of a second signal member disposed on the second lower arm, wherein:
(a) the second signal member produces a second signal;
(b) the receptor member is positioned so that it operably receives the second signal produced by the second signal member when the second signal member is positioned a predetermined distance from the receptor member, said predetermined distance corresponding to the most retracted state of the design range of motion of the frame; and
(c) the receptor member causes operation of the electric drive member to cease when the receptor member operably receives the second signal produced by the second signal member.

13. An appliance for lifting loads, the appliance comprising:
(a) an electrically powered lifting device, wherein the electrically powered lifting device is further comprised of a frame, an electric drive member, and electric drive connection means to operably connect the electric drive member to the frame so that the electric drive member causes the extension and retraction of the frame;
(b) non-mechanical switch means operably attached to the frame; and
(c) switch connecting means for connecting the non-mechanical switch means to the electric drive member;
(d) wherein the electrically powered lifting device has a design range of motion characterized by its most retracted state at one end of the range of motion of the frame and by its most extended state at the other end of the design range of motion of the frame, and the non-mechanical switch means causes the operation of the electric drive member to cease if the electrically powered lifting device attempts to operate outside of the design range of motion of the frame.

14. The appliance of claim 13, wherein the non-mechanical switch means is comprised of a magnetic switch.

15. The appliance of claim 13, wherein the non-mechanical switch means is comprised of an optical switch.

16. The appliance of claim 13, wherein the non-mechanical switch means is comprised of an infrared switch.

17. The appliance of claim 13, wherein:
(a) the frame is further comprised of two lower arms, two upper arms, a lifting plate, and a base, wherein:
(i) the two upper arms and the two lower arms each have two ends;
(ii) one end of each upper arm is pivotally connected to one end of a lower arm;
(iii) the other end of each upper arm is pivotally connected to the lifting plate;
(iv) the other end of each lower arm is pivotally connected to the base; and
(v) the lifting plate and the base move in the direction of the design range of motion of the frame; and
(b) the non-mechanical switch means is comprised of:
(i) a signal member disposed on one upper arm, wherein the signal member produces a signal; and
(ii) a receptor member disposed on the other upper arm, wherein:
(A) the receptor member is positioned so that it operably receives the signal produced by the signal member when the signal member is positioned a predetermined distance from the receptor member, said predetermined distance corresponding to the most extended state of the design range of motion of the frame; and
(B) the receptor member causes operation of the electric drive member to cease when the receptor member operably receives the signal produced by the signal member.

18. The appliance of claim 17, wherein the non-mechanical switch means is further comprised of a second receptor member disposed on the lower arm adjacent to the upper arm on which is disposed the signal member, wherein:
(a) the second receptor member is positioned so that it operably receives the signal produced by the signal member when the signal member is positioned a predetermined distance from the second receptor member, said predetermined distance corresponding to the most retracted state of the design range of motion of the frame; and
(b) the second receptor member causes operation of the electric drive member to cease when the second receptor member operably receives the signal produced by the signal member.

19. The appliance of claim 17, wherein the non-mechanical switch means is further comprised of a second signal member disposed on the lower arm adjacent to the upper arm on which is disposed the receptor member, wherein:
(a) the second signal member produces a second signal;
(b) the receptor member is positioned so that it operably receives the second signal produced by the second signal member when the second signal member is positioned a predetermined distance from the receptor member, said predetermined distance corresponding to the most retracted state of the design range of motion of the frame; and
(c) the receptor member causes operation of the electric drive member to cease when the receptor member operably receives the second signal produced by the second signal member.

20. The appliance of claim 13, wherein:
(a) the frame is further comprised of two lower arms, two upper arms, a lifting plate, and a base, wherein:
(i) the two upper arms and the two lower arms each have two ends;
(ii) one end of each upper arm is pivotally connected to one end of a lower arm;
(iii) the other end of each upper arm is pivotally connected to the lifting plate;
(iv) the other end of each lower arm is pivotally connected to the base; and
(v) the lifting plate and the base move in the direction of the design range of motion of the frame; and
(b) the non-mechanical switch means is comprised of:
(i) a signal member disposed on one lower arm, wherein the signal member produces a signal; and
(ii) a receptor member disposed on the upper arm adjacent to the lower arm on which is disposed the first signal member, wherein:
(A) the receptor member is positioned so that it operably receives the signal produced by the signal member when the signal member is positioned a predetermined distance from the receptor member, said predetermined distance corresponding to the most retracted state of the design range of motion of the frame; and
(B) the receptor member causes operation of the electric drive member to cease when the receptor member operably receives the signal produced by the signal member.

21. The appliance of claim 20, wherein the non-mechanical switch means is further comprised of a second signal member disposed on the other upper arm, wherein:
(a) the second signal member produces a second signal;
(b) the receptor member is positioned so that it operably receives the second signal produced by the second signal member when the second signal member is positioned a predetermined distance from the receptor member, said predetermined distance corresponding to the most extended state of the design range of motion of the frame; and
(c) the receptor member causes operation of the electric drive member to cease when the receptor member operably receives the second signal produced by the second signal member.

22. The appliance of claim 20, wherein the non-mechanical switch means is further comprised of a second receptor member disposed on the other lower arm, wherein:
(a) the second receptor member is positioned so that it operably receives the signal produced by the signal member when the signal member is positioned a predetermined distance from the second receptor member, said predetermined distance corresponding to the most extended state of the design range of motion of the frame; and
(b) the second receptor member causes operation of the electric drive member to cease when the second receptor member operably receives the signal produced by the signal member.

23. The appliance of claim 13, wherein:
(a) the electrically powered lifting device is further comprised of a control member operably connected to the electric drive member; and
(b) the control member controls the operation of the electrically powered lifting device.

24. The appliance of claim 13, wherein:
(a) the electrically powered lifting device is further comprised of an electrical power supply, a power cord, and a receptacle; and
(b) the receptable is operably connected to the power cord, and the receptacle and power cord together operably connect the electrical power supply to the electric drive member.

25. A method of using a lifting appliance with a non-mechanical safety shutoff switch, the method comprising the following steps:
(a) activating the lifting appliance so that it engages in lifting a load, wherein the lifting appliance is comprised of:
(i) a frame;
(ii) an electric drive member;
(iii) electric drive connection means to operably connect the electric drive member to the frame so that the electric drive member causes the extension and retraction of the frame;
(iv) a non-mechanical switch operably attached to the frame; and
(v) switch connecting means for connecting the non-mechanical switch to the electric drive member;
(vi) wherein the lifting appliance has a design range of motion characterized by its most retracted state at one end of the range of motion of the frame and by its most extended state at the other end of the design range of motion of the frame, and the non-mechanical switch causes the operation of the electric drive member to cease if the electrically powered lifting device attempts to operate outside of the design range of motion of the frame; and
(b) operating the lifting appliance until the non-mechanical switch causes the operation of the electric drive member to cease when the frame reaches its most extended state of the design range of motion or its most retracted state of the design range of motion.

26. The method of claim 25, wherein:
(a) the frame is further comprised of two lower arms, two upper arms, a lifting plate, and a base, wherein:
(i) the two upper arms and the two lower arms each have two ends;
(ii) one end of each upper arm is pivotally connected to one end of a lower arm;
(iii) the other end of each upper arm is pivotally connected to the lifting plate;
(iv) the other end of each lower arm is pivotally connected to the base; and
(v) the lifting plate and the base move in the direction of the design range of motion of the frame; and
(b) the non-mechanical switch is comprised of:
(i) a signal member disposed on an upper arm or a lower arm, wherein the signal member produces a signal; and
(ii) a receptor member disposed on the other upper arm or the other lower arm, respectively, wherein:
(A) the receptor member is positioned so that it operably receives the signal produced by the signal member when the signal member is positioned a predetermined distance from the receptor member, said predetermined distance corresponding to the most extended state of the design range of motion; and
(B) the receptor member causes operation of the electric drive member to cease when the receptor member operably receives the signal produced by the signal member.

27. The method of claim 26, wherein:
(a) the non-mechanical switch is further comprised of a second signal member disposed on the lower arm or the upper arm, respectively, that is pivotally attached to the upper arm or lower arm, respectively, on which is disposed the receptor member, wherein the second signal member produces a second signal;
(b) the receptor member is positioned so that it operably receives the second signal produced by the second signal member when the second signal member is positioned a predetermined distance from the receptor member, said predetermined distance corresponding to the most retracted state of the design range of motion of the frame; and
(c) the receptor member causes operation of the electric drive member to cease when the receptor member operably receives the second signal produced by the second signal member.

28. The method of claim 26, wherein:
(a) the non-mechanical switch is further comprised of a second receptor member disposed on the lower arm or the upper arm, respectively, that is pivotally attached to the upper arm or lower arm, respectively, on which is disposed the signal member;
(b) the second receptor member is positioned so that it operably receives the signal produced by the signal member when the signal member is positioned a predetermined distance from the second receptor member, said predetermined distance corresponding to the most retracted state of the design range of motion of the frame; and
(c) the second receptor member causes operation of the electric drive member to cease when the second receptor member operably receives the signal produced by the signal member.

29. The method of claim 26, wherein:
(a) the signal member is a magnet and the signal is a magnetic field produced by the magnet; and
(b) the receptor member is comprised of a switch mechanism and a sensor that detects magnetic fields, wherein the switch mechanism is activated by the sensor when the sensor operably receives the magnetic field signal produced by the signal member.

30. The method of claim 26, wherein:
(a) the signal member is comprised of a light source and the signal is a light beam produced by the light source; and
(b) the receptor member is comprised of a switch mechanism and a sensor that detects the light beam produced by the signal member, wherein the switch mechanism is activated by the sensor when the sensor operably receives the light beam produced by the signal member.

31. The method of claim 30, wherein the light beam produced by the light source is in the infrared wavelengths of the electromagnetic spectrum.
